(19) United States
(12) Patent Application Publication
(10) Pub. No.: US 2009/0278438 A1
(43) Pub. Date: Nov. 12, 2009

(54) PLASMA DISPLAY PANEL

(76) Inventors: Minoru Hasegawa, Miyazaki (JP); Akira Tokai, Miyazaki (JP); Shigeo Kasahara, Miyazaki (JP)

Correspondence Address: MCDERMOTT WILL & EMERY LLP, 600 13TH STREET, N.W., WASHINGTON, DC, 20005-3096, US

(21) Appl. No.: 12/158,394

(22) PCT Filed: Dec. 26, 2005
(86) PCT No.: PCT/JP2005/023789

§ 371 Date: Jun. 20, 2008

(51) Int. Cl. H01J 1/62; H01J 17/49

(52) U.S. Cl. 313/493; 313/582

(57) ABSTRACT

This invention provides a plasma display panel in which a blue fluorescent material layer is provided isolatedly from a green fluorescent material layer to prevent the green fluorescent material from being deteriorated. The plasma display panel includes fluorescent material layers of a plurality of colors provided between a pair of substrates. The fluorescent material layers are partitioned on a color to color basis with a barrier rib having predetermined width and height. Discharge is generated in the area partitioned by the barrier rib to perform display. At least one of the width and the height in the barrier rib for partitioning the blue fluorescent material layer from the green fluorescent material layer adjacent to the blue fluorescent material layer, is larger than that in the other barrier ribs.

### TECHNICAL FIELD

The present invention relates to a plasma display panel (PDP) having fluorescent material layers of three colors of R (red), B (blue) and G (green), partitioned by barrier ribs.

### BACKGROUND ART

In general, in a display panel of spontaneous light-emission type, for example, a plasma display panel, electrodes, a dielectric layer, barrier ribs, a dielectric layer and the like are formed on the inner face sides of two glass substrates that constitute the display panel.

In a typical three-electrode surface-discharge-type PDP of an AC-drive type, a number of display electrodes capable of surface-discharging are formed on an inner face of one of substrates on the front face side in a horizontal direction, and a number of address electrodes for use in selecting light-emitting cells are formed on an inner face of the other substrate on the back face side in a direction intersecting with the display electrodes so that each of intersections between the display electrodes and the address electrodes is designed to form one cell (unit light-emitting area).

In a full-color PDP, one pixel is configured by three cells, that is, R (red) cell, B (blue) cell and G (green) cell, and a barrier rib is formed between cells having different colors. Each of fluorescent material layers for R, G and B is formed between barrier ribs separating respective areas corresponding to the R cell, G cell and B cell. As a fluorescent material for R, for example, (Y, Gd)BO₃:Eu and Y₂O₃S:Eu are used. As a fluorescent material for B, for example, BaMgAl₁₀O₁₇:Eu and BaMgAl₁₄O₂₃:Eu are used. As a fluorescent material for G, for example, Zn₂SiO₄:Mn and Zn₂GeO₂:Mn are used.

The PDP is manufactured by processes in which, with the substrate on the front face side and the substrate on the back face side, thus prepared, being aligned face to face with each other, a sealing material is placed on the peripheral portion, and after the two substrates have been sealed by fusing the sealing material through a heating process, and a discharge gas is then sealed inside thereof. Non Patent Document 1: IEICETRANS. ELECTRON., Vol. E86-C, No. 11 November, p. 2253 (2003)

### DISCLOSURE OF THE INVENTION

### Problems to be Solved by the Invention

In the full-color PDP, the fluorescent material layers of three colors for R, G and B are formed as described above. In general, the blue fluorescent material has a characteristic of easily adsorbing moisture (for example, see Non-Patent Document 1) so that it also easily adsorbs organic components and the like together with moisture. These adsorbed water and organic components are isolated during discharge, and float in the panel. For this reason, these floating water and organic components cause deterioration in a fluorescent material of another color, for example, a green fluorescent material, resulting in a reduction in the light-emitting efficiency of the green fluorescent material.

The present invention has been devised to solve such problems, and its objective is to isolate the currently-used blue (For B) fluorescent material layer that discharges causal materials of deterioration in the fluorescent material from other fluorescent material layers, and consequently to prevent deterioration in the fluorescent material.

### Means for Solving the Problems

The present invention provides, in a plasma display panel including fluorescent material layers of a plurality of colors provided between a pair of substrates, the fluorescent material layers being partitioned on a color to color basis with a barrier rib having predetermined width and height so that discharge is generated in the area partitioned by the barrier rib to perform display, the plasma display panel which is characterized by that at least one of the width and the height in the barrier rib for partitioning a blue fluorescent material layer from a green fluorescent material layer adjacent to the blue fluorescent material layer, is larger than that in the other barrier ribs.

### EFFECTS OF THE INVENTION

In accordance with the present invention, the blue fluorescent material layer is provided isolatedly from the green fluorescent material layer by the barrier rib in which at least one of the width and the height is larger than that in the other barrier ribs, and hence the green fluorescent material can be prevented from being deteriorated.

### BRIEF DESCRIPTION OF THE DRAWINGS

FIG. 1 is an explanatory drawing that shows a structure of a PDP according to the present invention.

FIG. 2 is an explanatory drawing that shows a shape of barrier ribs according to Embodiment 1.

FIG. 3 is a side view that shows a panel according to Embodiment 1.

FIG. 4 is an explanatory drawing that shows a shape of barrier ribs according to Embodiment 2.

FIG. 5 is a side view that shows a panel according to Embodiment 2.

FIG. 6 is an explanatory drawing that shows a side face of a panel according to Embodiment 3.

FIG. 7 is an explanatory drawing that shows a side face of a panel according to Embodiment 4.

FIG. 8 is an explanatory drawing that shows a side face of a panel according to Embodiment 5.

FIG. 9 is an explanatory drawing that shows a side face of a panel according to Embodiment 6.

### REFERENCE NUMERALS

10 PDP
11 Substrate on front face side
12 Transparent electrode
13 Bus electrode
17, 24 Dielectric layer
18 Protective film
21 Substrate on back face side
28R, 28G, 28B Fluorescent material layer
29 Barrier rib
30 Discharge space
32 Contact layer
A Address electrode
L Display line
X, Y Display electrode

### BEST MODE FOR CARRYING OUT THE INVENTION

In the present invention, examples of a pair of substrates include a substrate made of glass, quartz or ceramics and a substrate prepared by forming desired constituent elements, such as an electrode, an insulating film, a dielectric film and a protective layer on, such a substrate.

In the present invention, as a fluorescent material for R, for example, (Y, Gd)BO₃:Eu and Y₂O₃S:Eu may be used. As a fluorescent material for B, for example, BaMgAl₁₀O₁₇:Eu and BaMgAl₁₄O₂₃:Eu may be used. As a fluorescent material for G, for example, Zn₂SiO₄: Mn and Zn₂GeO₂: Mn may be used.

The fluorescent material layer may be formed through processes in which a fluorescent material paste containing powder of the fluorescent material, a binder resin and a solvent is applied to the inside of a discharge space having a concave groove shape between barrier ribs by a screen printing method or a method using a dispenser, and after repeating this process for each of the respective colors, the resulting layers are fired. This fluorescent material layer may also be formed through a photolithography technique using a sheet-shaped fluorescent material layer material (a so-called green sheet) that contains powder of the fluorescent material, a photosensitive material and a binder resin. In this case, a sheet having a desired color is affixed onto the entire face of a display area on the substrate, and this is subjected to exposure and development, and by repeating these processes for each of the colors, fluorescent material layers having the respective colors can be formed between the corresponding barrier ribs.

In general, the blue fluorescent material easily adsorbs moisture and organic components, and the adsorbed moisture and organic components tend to be isolated during discharge to cause deterioration in fluorescent materials of the other colors. In particular, the deterioration in the green fluorescent material is serious.

Consequently, the barrier rib which partitions the blue fluorescent material layer and the green fluorescent material layer desirably has at least one of its width and height larger than that of the other barrier ribs.

Alternatively, with respect to both of the barrier rib which partitions the blue fluorescent material layer from the green fluorescent material layer and the barrier rib which partitions the blue fluorescent material layer from the red fluorescent material layer, at least one of the width and height thereof may be made larger than that in the other barrier ribs.

Any barrier rib may be used as long as it has predetermined width and height and it can partition the fluorescent material layers. The barrier rib may be formed by using a method, such as a sand blasting method, a printing method and a photoetching method. For example, in the sand blasting method, glass paste, made from a low-melting-point glass frit, a binder resin, a solvent and the like, is applied onto a substrate, and grinding particles are blasted onto the resulting substrate, with a grinding mask having apertures of a barrier rib pattern being placed thereon, so that the glass paste layer exposed to the mask openings is ground, and the resulting substrate is then fired; thus, barrier ribs are formed. Moreover, in the photoetching method, in place of grinding by using the grinding particles, a photosensitive resin is used as the binder resin, and after exposure and development by the use of a mask, the resulting substrate is fired so that barrier ribs are formed.

In the plasma display panel of the present invention, a discharge is generated in the area partitioned by the barrier rib to perform display.

In the present invention, the barrier rib which partitions the blue fluorescent material layer from the adjacent other red and green fluorescent material layers has at least one of its width and height larger than that in the other barrier ribs. That is, one of the width and the height of the barrier rib may be larger than that of the other barrier ribs, or both of the width and the height of the barrier rib may be larger than those of the other barrier ribs.

In the case when the width of a barrier rib is made larger than that in another barrier rib, that is, made wider than that of another, the degree of the width of the barrier rib needs to be sufficiently wide so that the resulting width exerts the corresponding effects. From this point of view, the width thereof is preferably set to 1.5 to 3 times wider than that of another barrier rib, more preferably, to about 2 times.

In the case when the height of a barrier rib is made larger than that of another barrier rib, that is, made higher than that of another, the degree of the height of the barrier rib needs to be sufficiently high so that the resulting height exerts the corresponding effects. From this point of view, the height thereof is preferably set to about 1.1 to 1.3 times higher than that of another barrier rib, more preferably, to about 1.2 times.

Moreover, in another aspect, the present invention relates to a plasma display panel in which a barrier rib for partitioning the blue fluorescent material layer from at least the adjacent fluorescent material layer having a green is made in tightly contact with the substrate on the side with no barrier ribs formed thereon by using a contact layer.

Furthermore, in still another aspect, the present invention relates to a plasma display panel in which the fluorescent material layers are arranged so that a blue fluorescent material layer and a green fluorescent material layer are disposed so that they are not adjacent each other.

Hereinafter, the present invention will be described in reference to embodiments shown in Figures. Note that the present invention is not limited thereto, and various modifications thereof may be possible.

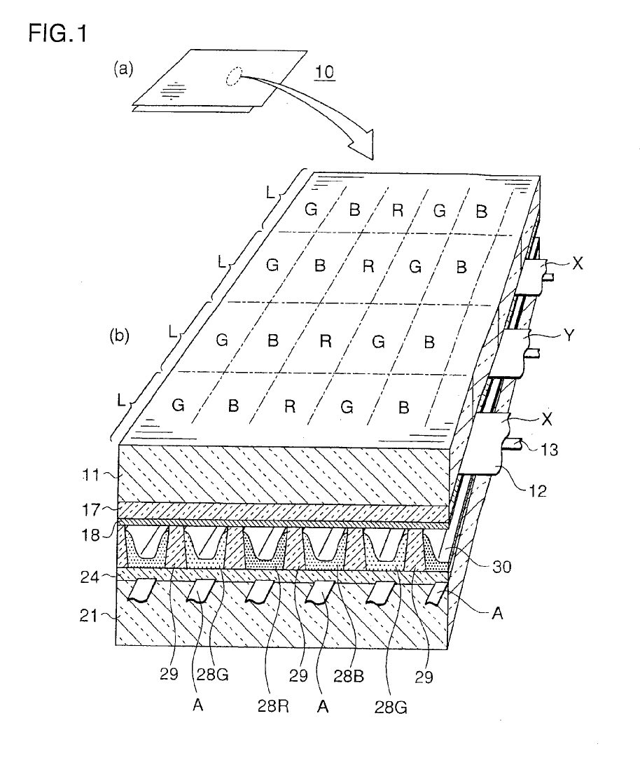

FIGS. 1(a) and 1(b) are explanatory drawings that show a structure of a PDP according to the present invention. FIG. 1(a) is an entire drawing, and FIG. 1(b) is a partially exploded perspective view. This PDP is an AC-drive type three-electrode surface discharge PDP for color display.

A PDP 10 is constituted by a substrate 11 on the front face side on which constituent elements having functions as the PDP are formed, and a substrate 21 on the back face side. As the substrate 11 on the front face side and the substrate 21 on the back face side, for example, a glass substrate, a quartz substrate, a ceramic substrate or the like may be used.

On the inner side face of the substrate 11 on the front face side, display electrodes X and display electrodes Y are disposed with equal intervals in a horizontal direction. All the gaps between adjacent the display electrodes X and the display electrodes Y form display lines L. Each of the display electrodes X and Y is constituted by a transparent electrode 12 having a wide width, made of ITO, SnO₂ or the like, and a bas electrode 13 having a narrow width, made of, for example, Ag, Au, Al, Cu, and Cr as well as a laminated body (for example, Cr/Cu/Cr laminated structure) or the like thereof. Upon forming these display electrodes X and Y, a thick-film-forming technique such as a screen-printing process is used for Ag and Au, and a thin-film-forming technique, such as a vapor deposition method and a sputtering method, and an etching technique are used for the other materials so that a desired number of electrodes having desired thickness, width and gap can be formed.

Here, in the present PDP, a PDP having a so-called ALIS structure in which display electrodes X and display electrodes Y are placed with equal intervals, with each gap between the adjacent display electrode X and display electrode Y being allowed to form a display line L, has been exemplified; however, the method for forming barrier ribs of the present invention may also be applied to a PDP having a structure in which paired display electrodes X and Y are placed separately with a distance (non-discharge gap) in which no discharge is generated.

On the display electrodes X and Y, an alternating-current (AC) driving dielectric layer 17 is formed in a manner so as to cover the display electrodes X and Y. The dielectric layer 17 is formed by processes in which a low-melting-point glass paste is applied onto a substrate 11 on the front face side by using a screen-printing method and fired thereon.

A protective film 18, used for protecting the dielectric film 17 from damage due to collision of ions generated by discharge upon displaying, is formed on the dielectric layer 17. This protective film is made from MgO. The protective film may be formed by using a known thin-film forming process in the corresponding field, such as an electron beam vapor deposition method and a sputtering method.

On the inner side face of the substrate 21 on the back face side, a plurality of address electrodes A are formed in a direction intersecting with the display electrodes X and Y on a plan view, and a dielectric layer 24 is formed in a manner so as to cover the address electrodes A. The address electrodes A, which generate an address discharge used for selecting cells to emit light at intersections with the display electrodes Y, is formed into a three-layer structure of Cr/Cu/Cr. These address electrodes A may be also formed by using another material, such as Ag, Au, Al, Cu and Cr. In the same manner as in the display electrodes X and Y, upon forming these address electrodes A, a thick-film-forming technique such as a screen-printing process is used for Ag and Au, and a thin-film-forming technique, such as a vapor deposition method and a sputtering method, and an etching technique are used for the other materials so that a desired number of electrodes having desired thickness, width and gap can be formed. A dielectric layer 24 is formed on the address electrodes A so as to cover the address electrodes A. The dielectric layer 24 can be formed by using the same material and the same method as those of the dielectric layer 17.

A plurality of barrier ribs 29 having a stripe shape are formed on the dielectric layer 24 between the adjacent address electrodes A. Not limited to this shape, the shape of the barrier ribs 29 may have a mesh shape (box shape) that divides the discharge space for each of the cells. The barrier ribs 29 are formed through a method, such as a sand blasting method, a printing method and a photoetching method. For example, in the sand blasting method, a glass paste, made from a low-melting-point glass frit, a binder resin, a solvent and the like, is applied onto a dielectric layer 24, and after this has been dried thereon, grinding particles are blasted onto the resulting glass paste layer, with a grounding mask having apertures of a barrier rib pattern being placed thereon, so that the glass paste layer exposed to the mask apertures is ground, and the resulting substrate is then fired; thus, barrier ribs are formed. Moreover, in the photoetching method, in place of grinding by using the grinding particles, a photosensitive resin is used as the binder resin, and after exposure and development by the use of a mask, the resulting substrate is fired so that barrier ribs are formed.

Although the barrier-ribs 29 are illustrated with the same size in the Figures, specific barrier ribs have a width and a height different from those of other barrier ribs. This point will be discussed later.

On the side faces of the barrier ribs 29 as well as on the dielectric layer 24 between the barrier ribs, fluorescent material layers 28R, 28B and 28G corresponding to red (R), blue (B) and green (G) are successively formed regularly along an extending direction of the display electrodes. The fluorescent material layers 28R, 28B and 28G are formed through processes in which a fluorescent material paste containing fluorescent material powder, a binder resin and a solvent is applied onto the inside of a discharge space having a concave groove shape between the barrier ribs 29 by using a screen-printing method or a method using a dispenser, and after these processes have been repeated for each of the colors, a firing process is carried out. These fluorescent material layers 28R, 28B and 28G may also be formed by using a photolithographic technique through processes in which a sheet-shaped fluorescent material layer material (so-called green sheet) containing fluorescent material powder, a photosensitive material and a binder resin is used. In this case, a sheet having a desired color may be pasted onto the entire face of a display area on a substrate, and the sheet is subjected to exposure and development, and this procedure us repeated for each color, thereby the fluorescent material layers having the respective colors can be formed in the corresponding gaps between the barrier ribs.

The PDP 10 is manufactured through processes in which the substrate 11 on the front face side having these constituent elements formed thereon and the substrate 21 on the back face side are placed so as to face each other in a manner so as to allow the display electrodes X, Y and address electrodes A to intersect with each other, and the peripheral portion thereof is sealed, with a discharge space 30 surrounded by barrier ribs 29 being filled with a discharge gas formed by mixing Xe and Ne. In this PDP, the discharge space 30 at each of intersections between the display electrodes X and Y and the address electrodes A forms one cell (unit light-emitting area) that is the minimum unit of display. One pixel is configured by three cells of R, B and G.

### Embodiment 1

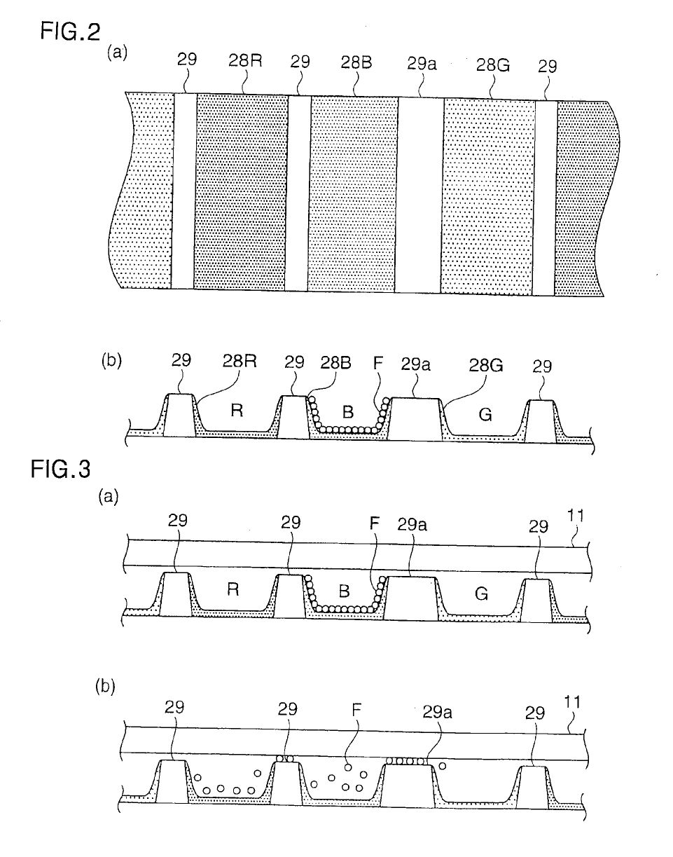

FIGS. 2(a) and 2(b) are explanatory drawings showing shapes of barrier ribs of Embodiment 1. FIG. 2(a) shows one portion of a substrate on the back face side on a plan view, and FIG. 2(b) is a side view of FIG. 2(a).

In the present Embodiment, the width of a barrier rib 29a between a blue fluorescent material layer 28B and a green fluorescent material layer 28G is made wider than the other barrier ribs 29. The width of the barrier rib 29a is about 2 times wider than that of the other barrier ribs 29. The height of the barrier rib 29a is the same as that of the other barrier ribs 29.

In the case when BaMgAl₁₀O₁₇:Eu or BaMgAl₁₀O₁₇:Eu is used as a fluorescent material (blue fluorescent material) for the blue fluorescent material layer 28B, (Y, Gd)BO₃:Eu or Y₂O₃S:Eu is used as a fluorescent material (red fluorescent material) for the red fluorescent material layer 28R, and Zn₂SiO₄:Mn or Zn₂GeO₂:Mn is used as a fluorescent material (green fluorescent material) for the green fluorescent material layer 28G, the blue fluorescent material has a characteristic of easily adsorbing moisture so that it also easily adsorbs organic components and the like together with water. For this reason, as shown in FIG. 2(b), impurities F such as water and organic components are adsorbed onto the blue fluorescent material layer 28B during manufacturing processes.

FIGS. 3(a) and 3(b) are panel side views of a panel manufactured by using a substrate on the back face side of Embodiment 1. FIG. 3(a) shows a state before discharge, and FIG. 3(b) shows a state during discharge.

After the production of a PDP, impurities F, adsorbed to the blue fluorescent material layer, are left as they are (see FIG. 3(a)). When a displaying process is executed on the PDP, that is, if a discharge is generated in the discharge space, the purities F, adsorbed on the blue fluorescent material layer, are isolated during discharge to float in the panel, and move through a gap between the barrier rib and the protective film on the substrate on the front face side (including a gap caused by the dimensional precision upon production) to adhere to another fluorescent material layer (see FIG. 3(b)). In this case, however, since the width of the barrier rib 29a between blue and green is made wider, that is, a longer distance between the blue fluorescent material layer and the green fluorescent material layer is provided, the impurities F, isolated from the blue fluorescent material layer, hardly move toward the green fluorescent material layer. Although the impurities F isolated from the blue fluorescent material layer are allowed to float and directed to the red fluorescent material layer, the fluorescent material of the red fluorescent material layer is hardly deteriorated by the impurities F; therefore, no problems arise even when they are directed to the red fluorescent material layer.

In this manner, the width of the barrier rib between the blue and green is widened to make the distance between the blue fluorescent material layer and the green fluorescent material layer longer so that the impurities that float from the blue fluorescent material layer are made to hardly reach the green fluorescent material layer.

In this case, a deterioration suppressing effect for the green fluorescent layer can be obtained even when all the widths of the barrier ribs are made thicker; however, when the widths of the barrier ribs are made thicker, a light emitting region is narrowed correspondingly, causing harmful side effects, such as deterioration in light-emitting efficiency and failure in achieving high precision. For this reason, the barrier ribs are made thicker only on the necessary portions.

### Embodiment 2

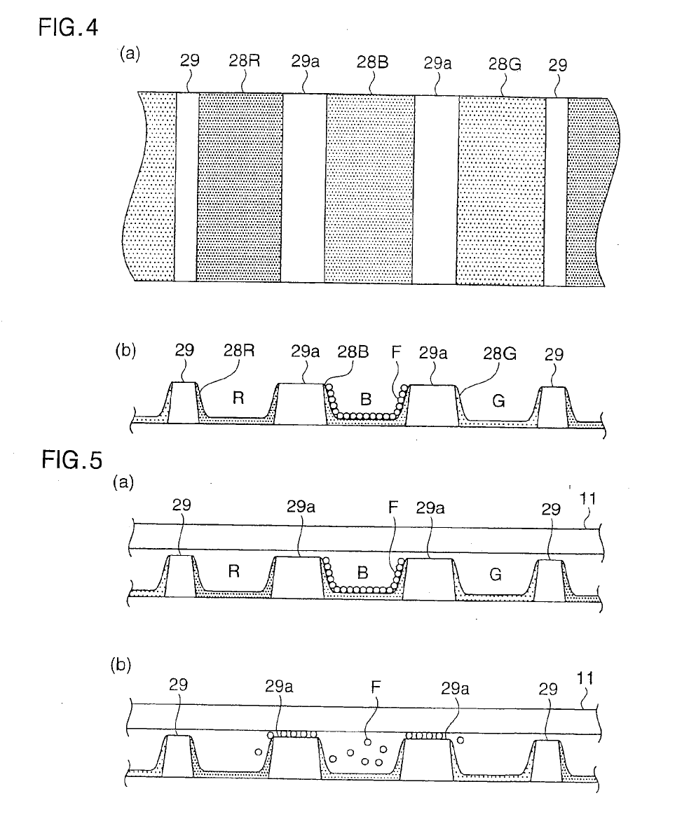

FIGS. 4(a) and 4(b) are explanatory drawings showing shapes of barrier ribs of Embodiment 2. FIG. 4(a) shows one portion of a substrate on the back face side on a plan view, and FIG. 4(b) is a side view of FIG. 4(a).

In the present Embodiment, the width of a barrier rib 29a between blue and green and the width of a barrier rib 29a between blue and red are made wider than the other barrier ribs 29. The width of the barrier rib 29a is about 2 times wider than that of the other barrier ribs 29. The height of the barrier ribs 29a is the same as that of the other barrier ribs 29.

FIGS. 5(a) and 5(b) are panel side views of a panel manufactured by using a substrate on the back face side of Embodiment 2. FIG. 5(a) shows a state before discharge, and FIG. 5(b) shows a state during discharge.

In Embodiment 1, impurities F, isolated from the blue fluorescent material layer, are allowed to float, and move toward the red fluorescent material layer, and then sometimes further move from the red fluorescent material layer toward the green fluorescent material layer. In this Embodiment, however, since the purities F, isolated by discharging, are not allowed to move to the red fluorescent material layer, the green is less vulnerable to deterioration in comparison with Embodiment 1.

A manufacturing method of the above described Embodiment 1 and Embodiment 2 will be described in the following.

First, address electrodes are formed on a substrate on the back face side by using Cr/Cu/Cr or an Ag paste. Next, a dielectric paste is applied thereto and fired thereon so that a dielectric layer covering the address electrodes is formed. Subsequently, a material paste for barrier ribs is applied to the dielectric layer by using a dip coating method or the like. A photosensitive sand blasting mask is applied thereto.

Next, the photosensitive sand blasting mask is exposed, and in this case, the exposed pattern is formed so that the width of a barrier rib between blue and green, or the width of a barrier rib between blue and green and the width of a barrier rib between blue and red, are made thicker than the width of a barrier rib between red and green. Here, even when the width of a barrier rib between red and green is made either thicker or thinner than the barrier rib between blue and green, the deterioration suppressing effect for the green fluorescent material is exerted; however, when thicker, the effect is higher.

After the widths of the barrier ribs have been made different by using exposure patterning processes through the photosensitive sand blasting masks, developing, sand blasting and mask-removing processes are carried out and the barrier rib material paste is then fired so that barrier ribs are formed. Even in the case when the barrier ribs are formed not by the sand blasting method, but by a photosensitive-rib method, the thickness of the barrier rib can be determined upon exposure in the same manner.

### Embodiment 3

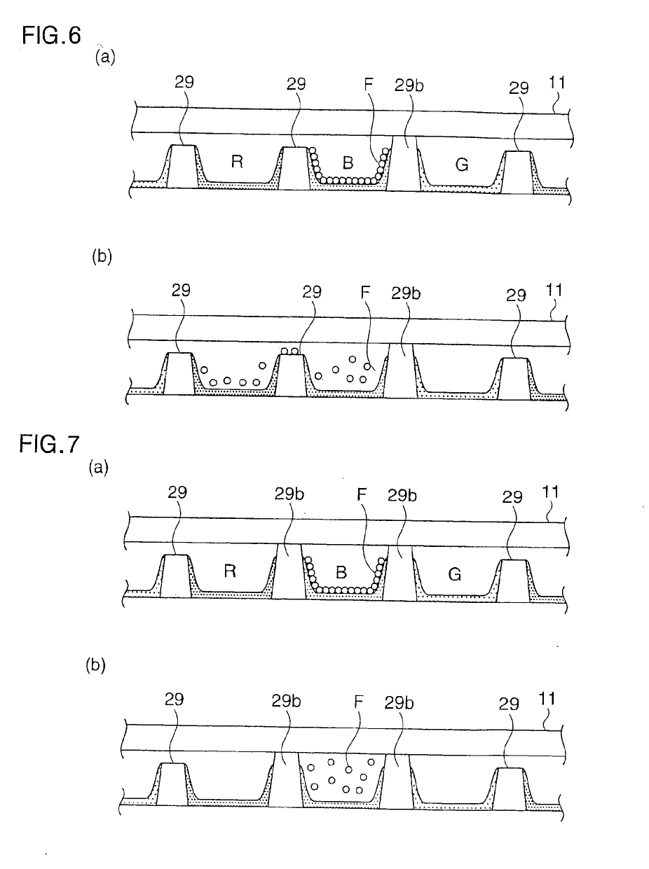

FIGS. 6(a) and 6(b) are explanatory drawings showing shapes of barrier ribs of Embodiment 3. FIG. 6(a) shows a state before discharge, and FIG. 6(b) shows a state during discharge.

In the present Embodiment, the height of a barrier rib 29b between blue and green is made higher than the other barrier ribs 29. The height of the barrier rib 29b is about 1.2 times higher than that of the other barrier ribs 29. The width of the barrier rib 29b is the same as that of the other barrier ribs 29.

After the production of a PDP, impurities F have been adsorbed to the blue fluorescent material layer (see FIG. 6(a)), and when a discharge is generated in a discharge space, the impurities F, adsorbed on the blue fluorescent material layer, are isolated during discharge to float in the panel (see FIG. 6(b)). However, since the height of the barrier rib 29b between the blue fluorescent material layer and the green fluorescent material layer is made higher, the impurities F, isolated from the blue fluorescent material layer, are hardly directed toward the green fluorescent material layer.

With respect to the method for making the height of the barrier rib 29b higher, a method may be used in which, after a grinding process of a coated barrier-rib material paste by using a sand blasting process or the like, the resulting material paste is fired so that barrier ribs 29 are formed, and barrier ribs 29 other than the barrier rib 29b between blue and green are ground by using a polishing process.

In the present Embodiment, the height of a barrier rib 29b between blue and green is made higher than the other barrier ribs 29. In other words, the height of a barrier rib 29 between blue and red and the height of a barrier rib 29 between red and green are made lower than the height of the barrier rib 29b between blue and green. Thus, by allowing impurities derived from the blue fluorescent material layer to easily flow toward the red fluorescent material layer, the impurities are made to hardly reach the green fluorescent material layer. In this case, since it is not necessary to make the width of the barrier rib 29b thicker, a wider light-emitting region can be maintained.

### Embodiment 4

FIGS. 7(a) and 7(b) are explanatory drawings showing shapes of barrier ribs of Embodiment 4. FIG. 7(a) shows a state before discharge, and FIG. 7(b) shows a state during discharge.

In the present Embodiment, the height of a barrier rib 29b between blue and green and the height of a barrier rib 29b between blue and red are made higher than the other barrier ribs 29. The height of the barrier rib 29b is about 1.2 times higher than that of the other barrier ribs 29. The width of the barrier rib 29b is the same as that of the other barrier ribs 29.

In Embodiment 3, impurities F, isolated from the blue fluorescent material layer, are allowed to float, and move toward the red fluorescent material layer, and then sometimes further move from the red fluorescent material layer toward the green fluorescent material layer. In this Embodiment, however, since the purities F, isolated by discharging, are not allowed to move to the red fluorescent material layer, the green fluorescent material layer is less vulnerable to deterioration in comparison with Embodiment 3.

The method for making the height of the barrier rib 29b higher is carried out by grinding the barrier rib between red and green.

Any combinations of the above-mentioned Embodiments 1 to 4 may be used. For example, with respect to the barrier rib between blue and green, both of its height and width may be made larger than those of the other barrier ribs. Moreover, with respect to each of the barrier rib between blue and green and the barrier rib between blue and red, both of its height and width may be made larger than those of the other barrier ribs. Moreover, the width of the barrier rib between blue and green may be widened, while the height of the barrier rib between blue and red may be made higher. Moreover, the structure opposite to this structure may be used.

### Embodiment 5

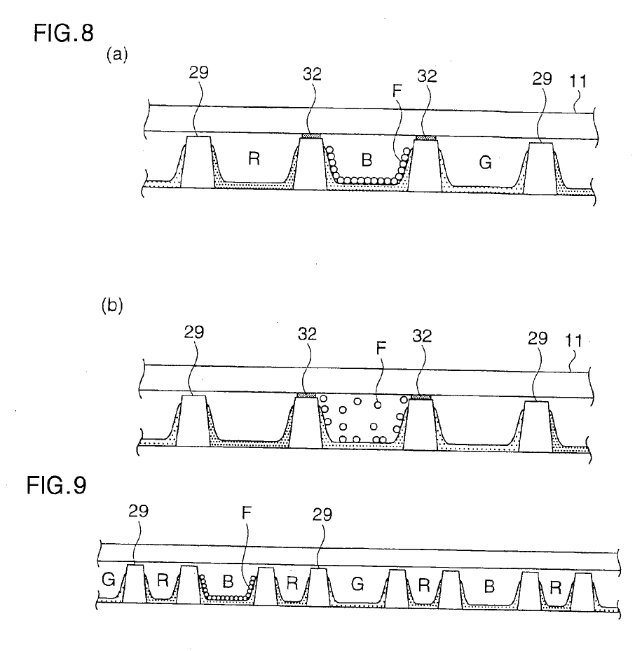

FIGS. 8(a) and 8(b) are explanatory drawings showing a side face of a panel having barrier ribs of Embodiment 5. FIG. 8(a) shows a state before discharge, and FIG. 8(b) shows a state during discharge.

In the present Embodiment, a contact layer 32 is formed on each of the top portion of the barrier rib 29 between blue and green and the top portion of the barrier rib 29 between blue and red. By using this contact layer, each of the top portions of the barrier rib 29 between blue and green and the top portion of the barrier rib 29 between blue and red is made in tightly contact with the substrate 11 on the front face side. No contact layer is formed on the top portion of the barrier rib 29 between green and red. The height and width of all the barrier ribs 29 have the same sizes. The contact layer 32 may be formed by applying a known low-melting point glass paste or the like in the corresponding field to be fired thereon.

In this manner, the barrier ribs 29 surrounding the blue fluorescent material layer are made in tightly contact with the substrate 11 on the front face side completely by using low-melting point glass or the like so that contaminants (causal materials of deterioration in the fluorescent material), isolated from the blue fluorescent material layer, can be confined in the formation region of the blue fluorescent material layer.

In the present Embodiment, the contact layers 32 are formed on the top portion of the barrier rib 29 between blue and green and the top portion of the barrier rib 29 between blue and red; however, the contact layer 32 may be formed only on the top portion of the barrier rib 29 between blue and green.

Upon producing this PDP, after the substrate on the front face side and the substrate on the back face side have been formed, a low-melting point glass paste is applied to the top portion of a barrier rib between blue and green of the substrate on the back face side or the top portions of the barrier ribs between blue and green as well as between blue and red, and these are temporarily fired to form temporary contact layers.

With respect to the material for the contact layer 32, by using the same low-melting point glass paste as that of the sealing member used for sealing the substrate on the front face side and the substrate on the back face side, the contact layer can be formed simultaneously with the sealing process of the substrate on the front face side and the substrate on the back face side. That is, before or after the coating process of the sealing material used for sealing the substrate on the back face side, the same sealing material is applied to the top portion of the barrier rib between blue and green or the top portions of the barrier ribs between blue and green as well as between blue and red. Thereby, the contact layer can be formed simultaneously with the sealing process of the substrate on the front face side and the substrate on the back face side in the succeeding seal firing process. By the formation of this contact layer, the blue fluorescent material layer and the green fluorescent material layer are completely partitioned from each other so that it is possible to make the green fluorescent material layer hardly exposed to contaminants isolated from the blue fluorescent material layer.

### Embodiment 6

FIG. 9 is an explanatory drawing that shows a side face of a panel according to Embodiment 6.

In the present Embodiment, the arrangement of fluorescent material layers is made so that 4 lines of [red, blue, red and green], such as color arrangements of red/blue/red/green/red/blue/red/green, are formed as one cycle.

In the above-mentioned arrangement, each blue fluorescent material layer and each green fluorescent material layer are always sandwiched by red fluorescent material layers. In this case, since one more red line is inevitably prepared, the cell pitch of the red fluorescent material layer is narrowed so that the red cell is constituted by two red lines.

The above-mentioned color arrangements may be formed as a cycle of [red/blue/black/green]. A cycle of [red/blue/black/green] provides a good color balance, which consequently gives an effect of improving contrast in the panel. A black dye, such as chromium oxide, is used as a black layer.

By using these color arrangements, the blue fluorescent material layer and the green fluorescent material layer are always kept at separated positions from each other so that contaminants isolated from the blue fluorescent material layer hardly reach the green fluorescent material layer.

As described above, according to the present invention, by making the width of the barrier rib between blue and green wider, or by making the height of the barrier rib higher, the blue fluorescent material layer that discharges causal substances of deterioration in the fluorescent material is separated from the green fluorescent material layer so that it becomes possible to prevent deterioration in the green fluorescent material.

Moreover, by forming a contact layer on the top portion of the barrier rib between blue and green, the blue fluorescent material layer that discharges causal substances of deterioration in the fluorescent material is isolated from the green fluorescent material layer so that it becomes possible to prevent deterioration in the green fluorescent material.

Alternatively, by preparing color arrangements as a cycle of four lines of red, blue, red and green, the blue fluorescent material layer that discharges causal substances of deterioration in the fluorescent material is isolated from the green fluorescent material layer so that it becomes possible to prevent deterioration in the green fluorescent material.

1. In a plasma display panel including fluorescent material layers of a plurality of colors provided between a pair of substrates, the fluorescent material layers being partitioned on a color to color basis with a barrier rib having predetermined width and height so that discharge is generated in the area partitioned by the barrier rib to perform display,
the plasma display panel which is characterized by that at least one of the width and the height in the barrier rib for partitioning a blue fluorescent material layer from a green fluorescent material layer adjacent to the blue fluorescent material layer, is larger than that in the other barrier ribs.

2. The plasma display panel according to claim 1,
wherein the fluorescent material layers of three colors of red, blue and green are regularly disposed, and
at least one of the width and the height in the barrier rib for partitioning the blue fluorescent material layer from the red fluorescent material layer, is larger than that in the barrier rib for partitioning the green fluorescent material layer from the red fluorescent material layer.

3. A plasma display panel comprising:
fluorescent material layers of a plurality of colors provided between a pair of substrates, the fluorescent material layers being partitioned on a color to color basis with a barrier rib having predetermined width and height so that discharge is generated in the area partitioned by the barrier rib to perform display,
wherein the barrier rib for partitioning a blue fluorescent material layer from a green fluorescent material layer adjacent to the blue fluorescent material layer is made in tightly contact with the substrate on which no barrier ribs are formed in the paired substrates by using a contact layer.

4. In a plasma display panel including fluorescent material layers of a plurality of colors provided between a pair of substrates, the fluorescent material layers being partitioned on a color to color basis with a barrier rib having predetermined width and height so that discharge is generated in the area partitioned by the barrier rib to perform display,
the plasma display panel which is characterized by that the fluorescent material layers are disposed in such a manner that a blue fluorescent material layer and a green fluorescent material layer are not adjacent to each other.

5. The plasma display panel according to claim 4, wherein the fluorescent material layers of red, blue and green are arranged in an extending direction of display electrodes as one cycle of four lines of red, blue, red and green, and two red lines are formed into one cell.
